(19) United States
(12) Patent Application Publication
(10) Pub. No.: US 2026/0120442 A1
(43) Pub. Date: Apr. 30, 2026

(54) DEVICE AND METHOD FOR OBJECT-CENTERED REPRESENTATION LEARNING THROUGH UNSUPERVISED SEMANTIC SEGMENTATION

(71) Applicant: UIF (UNIVERSITY INDUSTRY FOUNDATION), YONSEI UNIVERSITY, Seoul (KR)

(72) Inventors: Seong Jae Hwang, Seoul (KR); Chanyoung Kim, Seoul (KR); Woojung Han, Seoul (KR); Dayun Ju, Seoul (KR)

(73) Assignee: UIF (UNIVERSITY INDUSTRY FOUNDATION), YONSEI UNIVERSITY, Seoul (KR)

(21) Appl. No.: 18/934,108

(22) Filed: Oct. 31, 2024

(30) Foreign Application Priority Data
Oct. 30, 2024 (KR) 10-2024-0151577

(51) Int. Cl. G06V 10/774; G06V 10/762; G06V 10/764; G06V 10/77; G06V 20/40

(52) U.S. Cl. CPC G06V 10/7753; G06V 10/762; G06V 10/764; G06V 10/7715; G06V 20/46; G06V 20/49

(57) ABSTRACT

The present disclosure relates to a device for object-centric representation learning through unsupervised semantic segmentation, and includes a video encoding module that receives an input video and generate a feature map, an eigen clustering module that calculates an eigenvector representing a semantic structure of patches in the input video based on color affinity and semantic similarity of the input video, and generates a patch cluster for the patches in the input video through the eigenvector, and an object-centric contrastive learning module that generates an object prototype based on the patch cluster and distinguishes objects in the input video through semantic coherence based on the contrastive learning for the object prototype.

### CROSS-REFERENCE TO RELATED APPLICATION

This application claims under 35 U.S.C. § 119(a) the benefit of Korean Patent Application No. 10-2024-0151577 filed on Oct. 30, 2024, the entire contents of which is incorporated herein by reference.

### TECHNICAL FIELD

The present disclosure relates to an object-centric representation learning technology through unsupervised semantic segmentation, and more specifically, to a device and method for object-centric representation learning through unsupervised semantic segmentation capable of performing object-centric contrastive learning for generating an object prototype based on patch clusters and distinguishing objects in an input video through semantic coherence based on contrastive learning for the object prototype.

### BACKGROUND

Object-centered representation learning technology is a scheme of ascertaining a feature of a specific object in a scene or image and performing learning to understand a relationship and configuration between objects. This technology plays an important role in understanding objects specifically and contextually, especially in various artificial intelligence fields such as computer vision, autonomous driving, and robotics. Main elements are as follows:

Through object detection and segmentation, an image is segmented into several parts by distinguishing an object from a background, and a position and size of each object are defined. Through this, the model learns a boundary and shape of a specific object in the scene.

Through representation learning, a contextual relationship between main features (color, shape, size, and the like) of each object and a surrounding environment is ascertained and represented in a vector form. This vector representation helps the model understand visual features and semantic information of the object together, and enables consistent recognition of the objects in various scenes.

Through unsupervised learning, a scene is analyzed without prior labels, and similarity and relationship between objects are learned. This is useful for extension of understanding of new objects by ascertaining patterns of data, like human observation.

Through fine-grained feature analysis, detailed characteristics of the objects and a correlation between the objects are learned so that the objects are accurately understood even in complex scenes. For example, in autonomous driving, vehicles, pedestrians, and traffic lights on a road are clearly distinguished, and relationships between the vehicles, pedestrians, and traffic lights are ascertained in real time.

Such object-centric representation learning technology is being applied to greatly increase object recognition accuracy in visual perception of autonomous vehicles, object manipulation of robots, augmented reality, and the like. Further, the object-centric representation learning technology may be utilized to accurately recognize objects in medical video analysis, 3D modeling, or the like.

The object-centric representation learning technology provides an important basis for efficient processing and analysis of visual information centered on objects, and particularly, has a strength of high recognition performance in a complex environment in which multiple objects are included.

Korean Patent Publication No. 10-2022-0087567 (Jul. 15, 2022) discloses an object recognition and re-identification technology based on unsupervised contrastive learning using a camera and video tracklet. The learning method for object re-identification includes a step of generating a camera-level subdomain by classifying data of the camera based on a camera ID; and a step of performing contrastive learning on the subdomain through a dataset that uses an object tracklet ID classified by the data of the camera as a virtual label.

### PRIOR ART DOCUMENT

### Patent Document

Korean Patent Publication No. 10-2022-0087567 (Jul. 15, 2022)

### DESCRIPTION

### Problem to be Solved

An embodiment of the present disclosure is intended to provide a device and method for object-centric representation learning through unsupervised semantic segmentation capable of receiving an input video and generating a feature map.

An embodiment of the present disclosure is intended to provide a device and method for object-centric representation learning through unsupervised semantic segmentation capable of calculating an eigenvector representing a semantic structure of patches in an input video based on color affinity and semantic similarity of the input video and generating a patch cluster for the patches in the input video through the eigenvector.

An embodiment of the present disclosure is intended to provide a device and method for object-centric representation learning through unsupervised semantic segmentation capable of generating an object prototype based on a patch cluster and distinguishing objects in an input video through the semantic coherence based on the contrastive learning for the object prototype.

### Solution

In embodiments, a device for object-centric representation learning through unsupervised semantic segmentation includes a video encoding module configured to receive an input video and generate a feature map: an eigen clustering module configured to calculate an eigenvector representing a semantic structure of patches in the input video based on color affinity and semantic similarity of the input video, and generate a patch cluster for the patches in the input video through the eigenvector; and an object-centric contrastive learning module configured to generate an object prototype based on the patch cluster and distinguish objects in the input video through semantic coherence based on the contrastive learning for the object prototype.

The video encoding module may receive an original video and a transformed video obtained by transforming the original video through a vision transformer (ViT) as input videos.

The video encoding module may extract key features of different layers from the original video and the transformed video and integrates the key features to generate the feature map.

The eigen clustering module may segment the input video into patch units and calculate color affinity based on color information of each of the patches to generate a color affinity matrix.

The Eigen clustering module may perform an inner product between the patches on the feature map to generate a semantic similarity matrix indicating how semantically similar the respective patches are.

The Eigen clustering module may merge the color affinity matrix and the semantic similarity matrix to generate a Laplacian matrix, and eigendecompose the Laplacian matrix to calculate the eigenvector.

The Eigen clustering module may perform K-means clustering for the patches in the input video through the eigenvector and classify similar patches into the same object to generate the patch cluster (EiCue).

The object-centric contrastive learning module may select a center vector from the patch cluster or calculates a mean vector to determine the object prototype.

The object-centric contrastive learning module may perform intra-video contrastive learning and inter-video contrastive learning for the object prototype to learn semantic coherence of the object.

The object-centric contrastive learning module mya learn semantic distinction of the objects through contrastive learning between patch clusters.

In embodiments, a method for object-centric representation learning through unsupervised semantic segmentation performed in a device for object-centric representation learning through unsupervised semantic segmentation includes a video encoding step of receiving an input video and generating a feature map: an eigen clustering step of generating an eigenvector representing a semantic structure of patches in the input video based on color affinity and semantic similarity of the input video, and generating a patch cluster for the patches in the input video through the eigenvector; and an object-centric contrastive learning step of generating an object prototype based on the patch cluster and distinguishing objects in the input video through semantic coherence based on the contrastive learning for the object prototype.

### Effect

The disclosed technology can have the following effects. However, since this does not mean that a specific embodiment should include all of the following effects or only the following effects, the scope of the disclosed technology should not be understood as being limited thereby.

According to the device and method for object-centric representation learning through unsupervised semantic segmentation according to an embodiment of the present disclosure, it is possible to receive an input video and generate a feature map.

According to the device and method for object-centric representation learning through unsupervised semantic segmentation according to an embodiment of the present disclosure, it is possible to generate the eigenvector representing the semantic structure of the patches in the input video based on color affinity and the semantic similarity of the input video, and to generate the patch cluster for the patches in the input video through the eigenvector.

According to the device and method for object-centric representation learning through unsupervised semantic segmentation according to an embodiment of the present disclosure, it is possible to generate the object prototype based on the patch cluster and distinguish the objects in the input video through the semantic coherence based on the contrastive learning for the object prototype.

### BRIEF DESCRIPTION OF THE DRAWINGS

FIG. 1 is a drawing illustrating a device for object-centric representation learning through unsupervised semantic segmentation according to an embodiment of the present disclosure.

FIG. 2 is a diagram illustrating a functional configuration of the device for object-centric representation learning through unsupervised semantic segmentation of FIG. 1.

FIG. 3 is a diagram illustrating a system configuration of the device for object-centric representation learning through unsupervised semantic segmentation of FIG. 1.

FIG. 4 is a flowchart illustrating a method for object-centric representation learning through unsupervised semantic segmentation according to the present disclosure.

FIG. 5 is a diagram illustrating an EiCue generation process in the device for object-centric representation learning through unsupervised semantic segmentation of FIG. 1.

FIG. 6 is a visualization diagram of an eigenvector derived from S in an eigen aggregation module of the device for object-centric representation learning through unsupervised semantic segmentation of FIG. 1.

FIG. 7 is a diagram illustrating a comparison between results of learning using ViT-S/8 and ViT-B/8 backbones for (a) a COCO-Stuff dataset and (b) a Cityscapes dataset in the device for object-centric representation learning through unsupervised semantic segmentation of FIG. 1.

FIG. 8 is a diagram illustrating a comparison between K-means and EiCue in the device for object-centric representation learning through unsupervised semantic segmentation of FIG. 1.

FIG. 9 is a diagram of (a) hierarchical attention analysis and (b) eigengap analysis in the device for object-centric representation learning through unsupervised semantic segmentation in FIG. 1.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

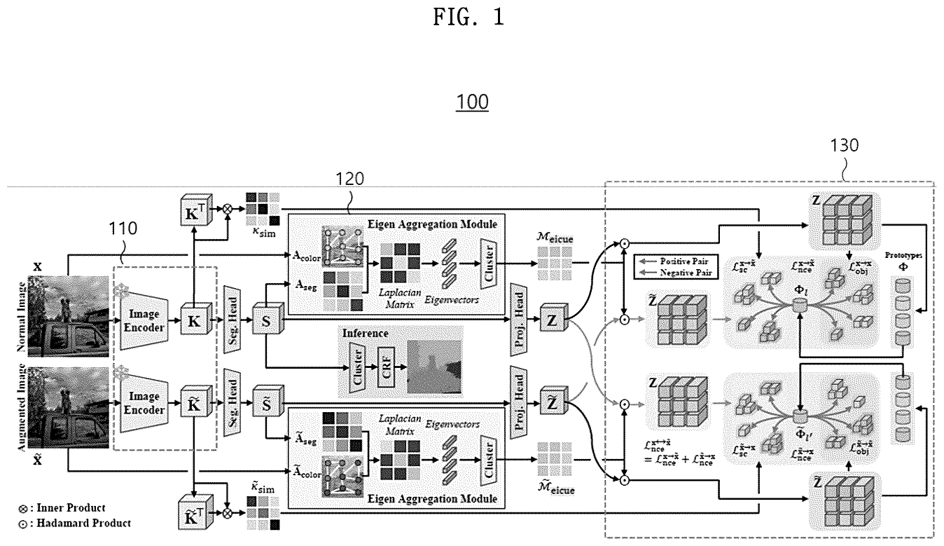

FIG. 1 is a drawing illustrating a device for object-centric representation learning through unsupervised semantic segmentation according to an embodiment of the present disclosure.

Referring to FIG. 1, a device for object-centric representation learning through unsupervised semantic segmentation 100 may include a video encoding module 110, an Eigen clustering module 120, and an object-centric contrastive learning module 130.

The video encoding module 110 may receive an input video and generate a feature map.

More specifically, an operation of the video encoding module 110 is as follows.

The video encoding module 110 performs various preprocessing tasks such as resolution adjustment, normalization, and noise removal of a video for preprocessing of the input video to prepare for stable feature extraction, thereby reducing unnecessary information of the video and increasing encoding efficiency.

Further, the video encoding module 110 may recognize and extract spatial features in the video using CNN layers for feature extraction based on a convolutional neural network (CNN), and ascertain various features such as a shape, boundary, and color of an object through convolution, pooling, and activation functions to gradually focus on important information and create a feature map.

Further, the video encoding module 110 may generate a high-dimensional feature map through several layers of the CNN for multi-layer feature map generation. The video encoding module 110 may extract low-dimensional low-level features (for example, an edge and texture) on an initial layer, and create high-dimensional semantic features (for example, a form or configuration of a specific object) on an upper layer, thereby forming a multi-layer feature map for each layer.

Further, the video encoding module 110 may improve a learning and inference speed by vectorizing and reducing a dimension while maintaining a key feature to increase processing efficiency.

The generated feature map may be used for image classification, object detection, video segmentation, semantic analysis, and the like. For example, the generated feature may be used to recognize objects in a road environment in autonomous driving, and to ascertain lesion areas in medical video analysis.

The Eigen clustering module 120 may generate the eigenvector representing a semantic structure of patches in the input video based on the color affinity and the semantic similarity of the input video, and generate a patch cluster for the patches in the input video through the eigenvector.

More specifically, an operation of the Eigen clustering module 120 is as follows.

The Eigen clustering module 120 may calculate a degree of similarity between the patches based on color information of the input video for color affinity and the semantic similarity analysis to measure the color affinity and analyze the semantic similarity in the video to define a relationship between the patches, thereby preparing for grouping the patches with similar colors and semantics.

Further, the Eigen clustering module 120 may calculate the eigenvector of the matrix by configuring a matrix that reflects color and semantic information of each patch for eigenvector calculation. This eigenvector is a vector that represents the semantic structure of the patches in the input video, and may compressively represent a semantic relationship between the patches.

Further, the Eigen clustering module 120 may perform spectral clustering based on the Eigenvector to cluster the patches. The spectral clustering may include semantically associated patches in the same cluster based on how close the patches are in an Eigenvector space.

Further, the Eigen clustering module 120 may segment the clustered patches into groups with similar semantic structures in the video for patch cluster generation. Each patch cluster may represent a specific semantic area of the video, and be segmented into areas of the same object or background, for example.

Further, the Eigen clustering module 120 may be utilized for semantic video segmentation, object detection, image search, and editing. In particular, the Eigen clustering module 120 may be advantageous in automatically grouping similar regions in the video to emphasize a specific object or semantic region.

The object-centric contrastive learning module 130 may generate an object prototype based on the patch cluster and distinguish the objects in the input video through the semantic coherence based on the contrastive learning for the object prototype.

More specifically, an operation of the object-centric contrastive learning module 130 is as follows.

The object-centric contrastive learning module 130 may generate an object prototype that represents a representative feature of the object by grouping patches that share similar semantic features based on the patch cluster generated by the Eigen clustering module for object prototype generation based on the patch cluster. The object prototype may be a high-dimensional vector that represents features such as color, shape, and texture of each object in a summarized manner.

Further, the object-centric contrastive learning module 130 may utilize a contrastive learning framework to enhance the semantic coherence of the object prototype. The object-centric contrastive learning module 130 may perform learning to make features between prototypes belonging to the same object closer and farther apart from prototypes of other objects. This object-centric contrastive learning module 130 can maximize the distinctiveness between objects through contrastive learning.

Further, the object-centric contrastive learning module 130 may construct samples between the same object (positive pair) and different objects (negative pair) for contrastive learning. Through this, the object-centric contrastive learning module 130 can perform learning so that the same objects become closer to each other and farther apart from other objects, and can further clarify a semantic boundary between the objects.

Further, the object-centric contrastive learning module 130 may enhance a unique semantic feature of each object prototype through contrastive learning for semantic coherence learning, and maximize coherence and distinctiveness between the objects. The object-centric contrastive learning module 130 may optimize the object prototype to be distinguished while maintaining the semantic coherence based on a relationship with the patch cluster in a learning process

Further, the object-centric contrastive learning module 130 may be used to precisely distinguish and interpret objects in image segmentation, object recognition, autonomous driving, augmented reality, and the like. In particular, the object-centric contrastive learning module 130 may recognize the objects with high accuracy even when the objects are not clearly distinguished in complex scenes.

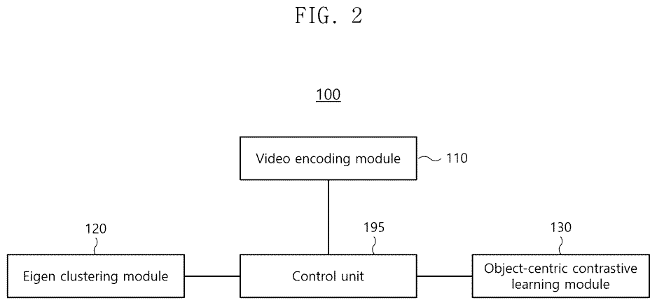

FIG. 2 is a diagram illustrating a functional configuration of the device for object-centric representation learning through unsupervised semantic segmentation of FIG. 1.

Referring to FIG. 2, the device for object-centric representation learning through unsupervised semantic segmentation 100 may include a video encoding module 110, an Eigen clustering module 120, and an object-centric contrastive learning module 130.

The video encoding module 110 a video encoding module may receive an original video and a transformed video obtained by transforming the original video through a vision transformer (ViT), as an input videos.

More specifically, the video encoding module 110 may receive the original video and the transformed video obtained by transforming the original video through ViT for input video collection. This transformed video may provide a visual pattern different from the original video, including various visual changes.

Further, the video encoding module 110 may segment the original video into patch units, and learn embedding for each patch to generate a transformation using ViT for vision transformer (ViT)-based transformation generation, thereby extracting features from various viewpoints and reflecting a semantic structure of the video more diversely.

Further, the video encoding module 110 may utilize the original video and the transformed video together for learning of various visual patterns, to help the module to better recognize a visual difference between the objects and the patches in the video and effectively ascertain the semantic similarity, thereby enabling learning in which changes in position and size of the object are considered.

Further, the video encoding module 110 can help the module understand the same object with more diverse representations by using two input videos to enhance unsupervised semantic segmentation, and can increase the accuracy of semantic segmentation using an unsupervised learning scheme. The video encoding module 110 may enable representation learning that reflects various transformations.

The video encoding module 110 may extract key features of different layers from the original video and the transformed video, and integrate the key features to generate the feature map.

More specifically, the video encoding module 110 may extract a key feature from each layer in the original video and the video transformed through ViT for multi-layer key feature extraction. Since each layer contains different levels of visual information, the video encoding module 110 may extract a basic feature such as an edge or a texture from a low-level layer, and complex information such as a shape or semantic structure from a high-level layer.

Further, the video encoding module 110 may learn various attributes of the objects and the patches in the video by utilizing the original video that provides basic features of the video and the transformed video that provides visual changes from various viewpoints for various visual information learning. As a result, the video encoding module 110 may utilize different visual information provided by the original video and the transformed video in a complementary manner.

Further, the video encoding module 110 may generate the feature map by integrating the key features extracted from the original video and the transformed video for key feature integration and feature map generation. This feature map may compress various visual information obtained from the original video and the transformed video into a single representation, thereby increasing the accuracy of object recognition and semantic segmentation.

Further, the video encoding module 110 may exhibit high performance in unsupervised semantic segmentation by utilizing an integrated feature map that includes both semantic distinction and visual coherence between the objects. Information extracted from various layers may reflect detailed characteristics and an overall structure of the object in a balanced manner in the object-centric representation learning.

Further, the video encoding module 110 may be applied in fields where semantic segmentation is important, such as autonomous driving, medical video analysis, and object recognition. The video encoding module 110 can accurately recognize and distinguish objects, especially in a complex scene.

The Eigen clustering module 120 may segment the input video into patch units and calculate color affinity based on color information of each patch to generate a color affinity matrix.

More specifically, the operation of the Eigen clustering module 120 is as follows.

The Eigen clustering module 120 may segment the input video into patch units of a fixed size for patch segmentation of the input video so that each patch represents a specific part of the video. The segmented patches may become basic units for extracting and analyzing color information thereafter.

Further, the Eigen clustering module 120 may extract the color information from each patch for color information extraction and quantify color features of each patch in a RGB or HSV color space. This color information may act as an important factor in measuring similarity between the patches.

Further, the eigen clustering module 120 may calculate color similarity between the patches to measure the color affinity for color affinity calculation. The eigen clustering module 120 may allow patches with similar colors to have higher affinity and reflect a color-centered relationship.

Further, the eigen clustering module 120 may generate a color affinity matrix based on color affinity calculated for color affinity matrix generation. This matrix may represent a color relationship between the patches, and the patches with high color affinity may have high values in the matrix. This matrix may be basic data that is used for clustering and segmenting objects thereafter.

The color affinity matrix is useful for ascertaining and clustering color-based semantic similarity in the object-centric representation learning, and may contribute to improving accuracy in semantic segmentation, object recognition, image editing, and the like.

The eigen clustering module 120 may perform an inner product between patches in the feature map to generate a semantic similarity matrix indicating how semantically similar the respective patches are.

More specifically, an operation of the eigen clustering module 120 is as follows.

The eigen clustering module 120 may receive the feature map generated in the previous step as an input and represent this as a feature vector in which each patch reflects various types of visual information. The patches in the feature map may include different visual and semantic information.

Further, the eigen clustering module 120 may perform an inner product between the feature vectors of each patch in the feature map for calculation of the inner product between patches to calculate the semantic similarity between the patches. An inner product result may provide a quantitative value as to how similar two patches are, and the greater value may mean that the two patches are more semantically similar.

Further, the eigen clustering module 120 may generate the semantic similarity matrix based on the inner product result between the patches. In this matrix, the semantic relationship between the patches is summarized, and patches with high similarity may have greater values. This makes it possible for the Eigen clustering module 120 to reflect a semantic structure between objects or regions in the video.

Further, the Eigen clustering module 120 may ascertain the semantic relationship between the patches through the su semantic similarity matrix and proceed to a spectral clustering step for object clustering. This matrix provides important information in the object-centric representation learning so that associated patches can be grouped.

The semantic similarity matrix may be utilized for semantic segmentation, object recognition, video analysis, and the like to contribute to semantically distinguishing the objects in the video and analyze an association thereof.

The Eigen clustering module 120 may merge the color affinity matrix and the semantic similarity matrix to generate a Laplacian matrix, and eigendecomposes the Laplacian matrix to calculate an eigenvector.

More specifically, an operation of the Eigen clustering module 120 is as follows.

The Eigen clustering module 120 may merge the color affinity matrix representing color similarity between the patches and the semantic similarity matrix representing the semantic similarity. The two matrices may be combined so that each patch can represent comprehensive similarity reflecting both the color and the semantic information.

Further, the Eigen clustering module 120 may generate the Laplacian matrix based on the merged similarity matrix. The Laplacian matrix is a basic structure that helps to form semantically similar patches in a video into a single group by connecting patches with high similarity to each other.

Further, the Eigen clustering module 120 may eigendecompose the generated Laplacian matrix to calculate an eigenvalue and an eigenvector. The eigenvector is a vector that reflects a structural relationship and semantic coherence between the patches, and may represent how semantically similar the patches are in the video.

Further, the Eigen clustering module 120 may use the generated eigenvector to cluster the semantically similar patches. Based on this eigenvector, the Eigen clustering module 120 may perform the spectral clustering to identify and segment associated object areas within the video.

Further, the eigen clustering module 120 may enhance the distinctiveness between objects in the object-centric representation learning and allows various patches to be effectively segmented into semantic groups in semantic segmentation, object recognition, autonomous driving, and the like.

The eigen clustering module 120 may perform K-means clustering on the patches in the input video using the eigenvector and classify similar patches into the same object to generate a patch cluster (EiCue).

More specifically, an operation of the eigen clustering module 120 is as follows.

The eigen clustering module 120 may reflect a semantic feature of each patch using eigenvectors generated through eigendecomposition of the Laplacian matrix. The eigenvector contains information including an indication of how similar the patches are in terms of color and semantics, and may be the basis for clustering.

Further, the Eigen clustering module 120 may apply a K-means clustering algorithm by utilizing the eigenvectors for K-means clustering. Through this, the Eigen clustering module 120 may group the patches based on a distance between the eigenvectors and classify similar patches into the same cluster to group the semantically similar patches in the input video into one object.

Further, the Eigen clustering module 120 may define a group of patches grouped according to the semantic similarity as a patch cluster (EiCue) as a result of performing the K-means clustering to generate the patch cluster (EiCue). Each EiCue represents a specific object or semantic area in the video, and similar patches form one cluster so that object-centric distinguishment can be made.

Further, the Eigen clustering module 120 may classify the patches belonging to the same patch cluster into one object to enhance object classification and semantic coherence, thereby increasing the accuracy of semantic segmentation and object recognition. This makes it possible for the Eigen clustering module 120 to effectively distinguish several objects in the input video and secure a semantically consistent object-centric representation.

Further, the Eigen clustering module 120 may be utilized in various fields that require object-centric semantic segmentation and recognition in autonomous driving, medical video analysis, image editing, or the like.

The object-centric contrastive learning module 130 may select a center vector from the patch cluster or calculate an average vector to determine the object prototype.

More specifically, an operation of the object-centric contrastive learning module 130 is as follows.

The object-centric contrastive learning module 130 may select the center vector from each patch cluster (EiCue) and use a representative feature of the cluster as an object prototype. The center vector may reflect the most characteristic and semantically central patch in the cluster, so that the center vector can well represent the object of the cluster.

Further, the object-centric contrastive learning module 130 may calculate a vector average of all the patches in the cluster instead of the center vector for patch cluster average vector calculation, and use the average vector indicating combined features of the respective patches used as the object prototype. The average vector may reflect consistent features of the entire cluster to provide a comprehensive representation of the object.

Further, the object-centric contrastive learning module 130 may select one of the center vector and the average vector to determine the selected vector to be a final object prototype. This object prototype may be a high-dimensional vector that is a summary of semantic features of the respective clusters and may be an important criterion for comparison and learning between the objects.

Further, the object-centric contrastive learning module 130 may perform contrastive learning using the object prototype for differentiation between the objects through the contrastive learning, thereby enhancing the semantic distinction between the respective object prototypes. The object-centric contrastive learning module 130 may secure the distinctiveness between the objects while maintaining the semantic coherence by increasing the similarity between the same object prototypes and keeping a distance from other object prototypes.

Further, the object-centric contrastive learning module 130 may be useful for enhancing the semantic distinction between the objects in semantic segmentation, object recognition, video analysis, and the like, and increasing the accuracy of the object recognition in various application fields.

The object-centric contrastive learning module 130 may perform intra-video contrastive learning and inter-video contrastive learning on the object prototype to learn the semantic coherence of objects.

More specifically, an operation of the object-centric contrastive learning module 130 is as follows.

The object-centric contrastive learning module 130 may maintain coherence by learning patches that share the same object prototype within a video for intra-image contrastive learning. Different objects within the same video can be compared with each other, the similarity between the same object prototypes can be increased, and learning is performed so that the prototypes can be distinguished from other object prototypes, making it possible for each object to be clearly distinguished within the same video.

The object-centric contrastive learning module 130 may perform learning so thalt objects with similar semantics in different videos are recognized as the same object prototype for inter-video contrastive learning. The object-centric contrastive learning module 130 associates objects with the same semantic characteristics in various videos with each other and differentiates the objects from semantically different objects, thereby securing consistent object representation in various videos.

The object-centric contrastive learning module 130 may enable the object prototype to appear consistently inside and outside the video through intra-video and inter-video contrastive learning to enhance the semantic coherence of the object prototype. This makes it possible for the object-centric contrastive learning module 130 to enhance the same object prototype so that the same object prototype has the semantic coherence in various videos and is recognized with the same semantics in various situations.

The object-centric contrastive learning module 130 may maintain the coherence of the same object along with clear distinction between the objects for a differentiation effect of the contrastive learning, so that each object is stably recognized even under various video conditions, thereby increasing the precision of the object recognition and enabling semantically rich representation learning.

The object-centric contrastive learning module 130 can be utilized in various AI application fields such as autonomous driving, object tracking, and video segmentation, and is particularly suitable for applications that require semantic coherence of the objects in several scenes or under various conditions.

The object-centric contrastive learning module 130 may learn semantic distinction of objects through contrastive learning between patch clusters.

More specifically, an operation of the object-centric contrastive learning module 130 is as follows.

The object-centric contrastive learning module 130 recognizes that each patch cluster (EiCue) is a set of semantically similar patches and represents a specific object or part of the object, and learns distinctiveness between different patch clusters through contrastive learning so that the objects may be distinguished as different objects.

Further, the object-centric contrastive learning module 130 may perform learning by regarding patches within the same patch cluster as positive pairs and setting other clusters as negative pairs for generation of positive and negative pairs. Accordingly, the object-centric contrastive learning module 130 may perform learning so that the patches in the same cluster maintain a close relationship and have a distance from other clusters, thereby clearly distinguishing between objects.

Further, the object-centric contrastive learning module 130 may enhance a semantic boundary of the object represented by each patch cluster through contrastive learning. The object-centric contrastive learning module 130 may perform learning so that clusters representing the same object have similarity and have a differentiated representation from clusters representing different objects.

Further, the object-centric contrastive learning module 130 may precisely perform semantic distinction through contrastive learning between patch clusters even in a complex scene containing various objects to improve the precision of object distinction. The object-centric contrastive learning module 130 may set a clear boundary between objects in tasks such as semantic segmentation and object recognition.

Further, the object-centric contrastive learning module 130 may be utilized when precise distinction of objects is required in autonomous driving, video segmentation, video search, and the like, and may be suitable for, particularly, distinguishing various objects while maintaining semantic coherence.

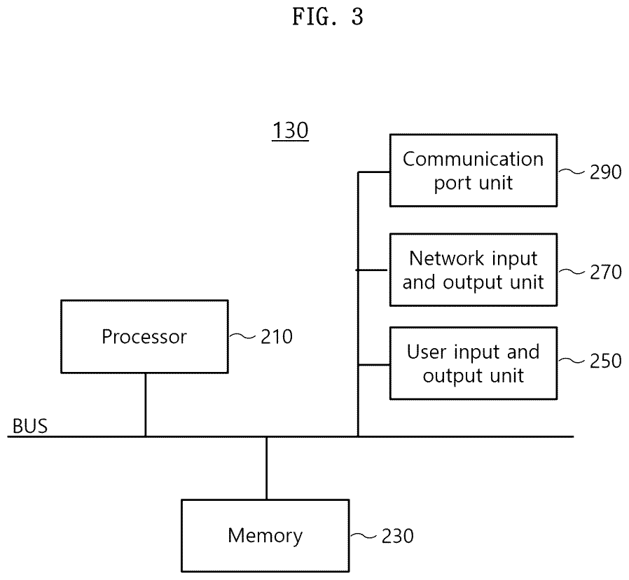

FIG. 3 is a diagram illustrating a system configuration of a device for object-centric representation learning through unsupervised semantic segmentation of FIG. 1.

Referring to FIG. 3, the device for object-centric representation learning through unsupervised semantic segmentation 100 may include a processor 210, a memory 230, a user input and output unit 250, a network input and output unit 270, and a communication port unit 290.

The processor 210 may receive a question including a video and text through a text-only language model and a vision-language model, generate a text response and a multimodal response to the question, manage the memory 230 that is read or written in such a process, and schedule a synchronization time between a volatile memory and a nonvolatile memory in the memory 230. The processor 210 may control an overall operation of a dialect conversion device 100 based on QLoRA, and may be electrically connected to the memory 230, the user input and output unit 250, the network input and output unit 270, and the communication port unit 290 to control data flows between these units. The processor 210 may be implemented as a central processing unit (CPU) or a graphics processing unit (GPU) of the dialect conversion device 100 based on QLoRA.

The memory 230 may include an auxiliary memory device implemented as a non-volatile memory such as a solid state disk (SSD) or a hard disk drive (HDD) and used to store all of data required for the device for object-centric representation learning through unsupervised semantic segmentation 100, and may include a main memory device implemented as a volatile memory such as a random access memory (RAM). Further, the memory 230 may store a set of instructions that execute a role of the dialect conversion device 100 based on QLoRA according to the present disclosure by being executed by the electrically connected processor 210.

The user input and output unit 250 may include an environment for receiving a user input and an environment for outputting specific information to a user, and may include, for example, an input device including an adapter such as a touch pad, a touch screen, a visual keyboard, or a pointing device, and an output device including an adapter such as a monitor or a touch screen. In an embodiment, the user input and output unit 250 may correspond to a computing device connected via a remote connection, and in such a case, the device for object-centric representation learning through unsupervised semantic segmentation 100 may function as an independent server.

The network input and output unit 270 may provide a communication environment for connection to an attack IP terminal or a test IP terminal through a network, and may include, for example, an adapter for communication such as a local area network (LAN), a metropolitan area network (MAN), a wide area network (WAN), and a value added network (VAN). Further, the network input and output unit 270 may be implemented to provide a short-distance communication function such as WiFi or Bluetooth or a wireless communication function of 4G or higher for wireless transmission of data.

The communication port unit 290 is a hardware interface for connection to external hardware, and for example, the external hardware may include a printer, a mouse, and USB hardware. The communication port unit 290 may detect a connection of specific USB hardware and perform a role of a CTI enhancement device 130.

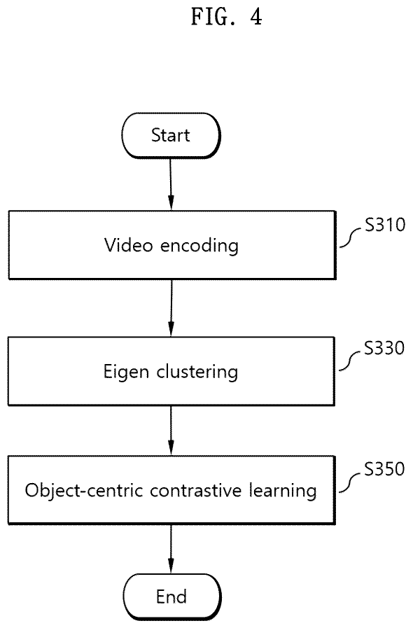

FIG. 4 is a flowchart illustrating a method for object-centric representation learning through unsupervised semantic segmentation according to the present disclosure.

In FIG. 4, the device for object-centric representation learning through unsupervised semantic segmentation 100 performs a video encoding step for receiving an input video and generating a feature map (step S310), an eigen clustering step of calculating the eigenvector representing the semantic structure of the patches in the input video based on color affinity and the semantic similarity of the input video, and generating the patch cluster for the patches in the input video through the eigenvector (step S330), and an object-centric contrastive learning step of generating an object prototype based on the patch cluster and distinguishing the objects in the input video through the semantic coherence based on contrastive learning for the prototype (step S350).

In step S310, the video encoding module 110 may comprehensively reflect various pieces of information of the input video to generate a meaningful feature map, and then provide basic data for a object classification and recognition process.

In step S330, the Eigen clustering module 120 analyzes colors and a semantic relationship of the patches in the input video, and generates an object-centric patch cluster reflecting the semantic structure through eigenvectors and clustering, thereby improving performance in subsequent learning and recognition steps.

In step S350, the object-centric contrastive learning module 130 can contrastively learn the object prototypes based on patch clusters and distinguishes the objects in the video with semantic coherence and enable stable object recognition under various conditions.

### 1. Methodology

### Core Unsupervised Semantic Segmentation (USS) Framework Based on Pretrained Model

### 1.1. Base Step

### Unlabeled Image

The present approach is based on a set of unannotated images, denoted as X={xb}^{B}_{b=1}, where B is the number of training images in a mini-batch. A set of augmented images \tilde{X}={\tilde{x}_{b}}^{B}_{b=1}=P(X) is generated by using an optical augmentation strategy P.

### Pretrained Feature K

For each input image xb, a hierarchical attention key feature is extracted from last three blocks using a self-supervised vision transformer as an image encoder F. Specifically, K_{L-2}=F_{L-2}(x_{b}), K_{L-1}=F_{L-1}(x_{b}), and K_{L}=F_{L}(x_{b}), where L−2, L−1, and L represent last layers including a third layer, a second layer, and a last layer, respectively. This is concatenated to one attention tensor K=[K_{L-2}; K_{L-1}: K_{L}]∈R\hat{ }(H×W×D_{K}). Similarly, the same procedure is applied to an augmented image \tilde{x}_{b} to obtain the attention tensor \tilde{K}∈R\hat{ }(H×W×D_{K}).

### Semantic Feature S

K is known to contain some structural information for the object through an attention mechanism, but lack semantic information for direct inference. Therefore, for additional feature refinement, a semantic feature S=S_{θ}(K∈R\hat{ }(H×W×D_{S}) and \tilde{S}=S_{θ}(\tilde{K})∈R\hat{ }(H×W×D_{S}) are calculated, where S_{θ}: R\hat{ }(H×W×D_{K})→R\hat{ }(H×W×D_{S}) is a learnable nonlinear segmentation head. For brevity, a total number of patches H×W is denoted by N.

### Inference

In inference, a semantic feature S of a new image serve as a basis for additional clustering for a final semantic segmentation output through en existing evaluation setting such as K-means clustering or linear probing. Therefore, learning S_{θ} to output the robust semantic feature S in an unsupervised manner, as in previous pretrained feature-based USS tasks, is the basis of a modern USS framework.

### 1.2. Eigen set (EiCue) Generation: Eigen Aggregation Module

Intuitively, a “semantically valid” object-level segment is said to be a group of pixels that accurately capture a structure of an object even when there is a complex structural variation. For example, a car segment should contain all components of the car, such as a windshield, a door, and a wheel, which may appear in various shapes and angles. However, inferring such a structure without pixel-wise annotations that provide object-level semantics is a very difficult task in a state of the absence of object-level structural prior information.

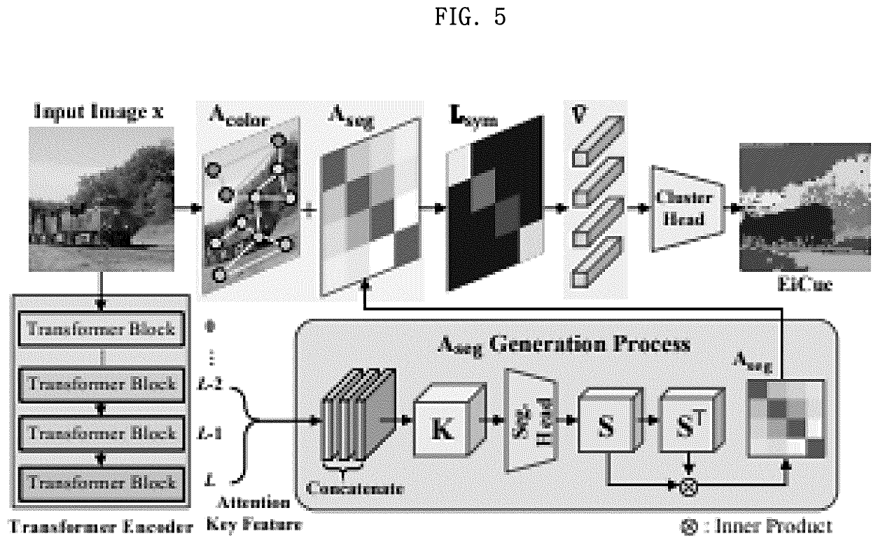

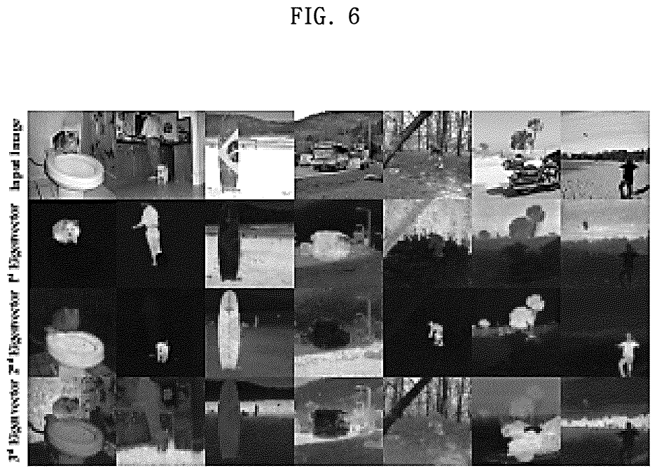

Recognizing this, an EAGLE model first aims at deriving a powerful and simple semantic structural cue, EiCue, based on an eigen basis of the feature similarity matrix (see FIG. 5). Specifically, an unsupervised feature representation that captures a nonlinear structure capable of processing data of a complex pattern using a well-known spectral clustering technique is obtained. The unsupervised feature representation traditionally works only in a color space, but may be extended by utilizing a similarity matrix configured of other features. Such a spectral method is particularly useful for a real complex image as in FIG. 6.

### EiCue Generation Process

A process of generating EiCue will be described in detail as suggested in FIG. 5. The overall framework generally follows a basic spectral clustering procedure. The main steps are as follows:

### Generation of Adjacency Matrix A

First, an adjacency matrix A is constructed based on the similarity between pixels or patches.

### Generation of Graph Laplacian L

A graph Laplacian L is generated based on the adjacency matrix A to represent structural information reflecting a similarity relationship.

### Performing of Eigendecomposition of L

Eigendecomposition is performed on the graph Laplacian L to derive an eigenbasis V, and generate an eigenfeature to be used to cluster each patch.

### 1.2.1 Generation of Adjacency Matrix

The adjacency matrix includes two components: (1) color affinity matrix and (2) a semantic similarity matrix.
Color Affinity Matrix A_{color}

The color affinity matrix is computed as a color distance using RGB values of the image x. This matrix evaluates the color affinity using the Euclidean distance between specific patch positions p and q in the image. Here, x∈R^{H×W×3} is a version of original image resolution adjusted according to patch resolution, ensuring compatibility with other adjacency matrices. As a result, the color affinity matrix A_{color}∈R^{N×N} represents a color-based relationship between the patches as a pair. Specifically, an RBF kernel is used as a distance function, and a value of the color affinity matrix is calculated as follows.

$${A}_{color} ( p , q ) = exp ( - {‖ {x}^{\text{?}} ( p ) - {x}^{\text{?}} ( q ) ‖}_{2} / 2 {{σ}_{\text{?}}}^{2} )$$

$$\text{?} \text{indicates text missing or illegible when filed}$$

Here, σ_{c}>0 is a freely adjustable hyperparameter. Further, in order to cause only close patches to have an influence on each other's affinity value, a maximum distance between patch pairs is restricted, and the affinity only for patch pairs in a predefined spatial distance is calculated.

### Semantic Similarity Matrix A_{seg}

The semantic similarity matrix A_{seg}∈R^{N×N} includes a product of a tensor S and a transpose matrix S^{T} thereof. The tensor S is obtained by processing attention key features hierarchically combined in last three layers of a pretrained vision transformer with a segmentation head S_{θ}.
Adjacency Matrix A

A final adjacency matrix A is defined as a sum of A_{color} and A_{seg}, and A=A_{color}+A_{seg}. This adjacency matrix represents a semantic relationship through a combination of high-level information including color information with network-based deep features. Image-based A_{color} maintains the structural coherence of the image and complements contextual information of the image. Subsequently, A_{seg} including the learnable tensor S further enhances such a property to improve semantic interpretation of the object without compromising the structural coherence, and acts as an important clue in the learning process.

### 1.2.2 EigenDecomposition

To construct EiCue based on AAA, the Laplacian matrix is generated. The Laplacian matrix is defined as follows:

$$L = D - A$$

Here, D is a degree matrix of A and is defined as

$$D ( i , i ) = {Σ}_{j = 1}^{N} A ( i , j ) .$$

In this method, a normalized Laplacian matrix is used for improved clustering performance. A symmetric normalized Laplacian matrix L_{sym} is defined as follows:

$${L}_{s y m} = {D}^{- 1 / 2} L {D}^{- 1 / 2}$$

Then, eigendecomposition is performed on L_{sym} to calculate the eigen basis V∈R^{N×N}. Here, each column corresponds to an eigenvector. Then, k eigenvectors corresponding to k smallest eigenvalues are extracted and combined into \hat{V}∈R^{N×k}. Here, an i-th row of \hat{V} represents a k-dimensional eigenfeature for an i-th patch.

### 1.2.3 Differentiable Eigen Clustering

After the eigenvector \hat{V} is obtained, an eigenvector clustering process is performed to extract EiCue as M_{eiCue}∈R^{N}. A mini-batch K-means algorithm based on a cosine distance between \hat{V} and a cluster center C is used to cluster the eigenvectors. In this case, the cluster center C∈R^{k×C} includes learnable parameters. To learn C, additional training is performed using the following loss function.

$${ℒ}_{\text{?}}^{x} = - \frac{1}{N} {\sum }_{i = 1}^{N} ( {\sum }_{c = 1}^{C} {Ψ}_{\text{?}} {P}_{\text{?}} ) , \qquad ( 1 )$$

$$\text{?} \text{indicates text missing or illegible when filed}$$

Here, C is the number of predefined classes, Ψ:=softmax(P), and P_{ic} and Ψ_{ic} represent the i-th patch and a c-th cluster number in P and Ψ, respectively. The same procedure is applied to an augmented image x to obtain

$${L}_{eig}^{\tilde{x}} .$$

A cluster center that enables more effective clustering by minimizing

$${L}_{eig} = 1 / 2 ( {L}_{eig}^{x} + {L}_{eig}^{\tilde{x}} )$$

can be obtained. Then, EiCue is calculated as follows:

$$ℳ \text{?} ( i ) = arg max \text{?} ( P \text{?} - log ( \sum \text{?} exp ( P \text{?} ) ) ) . \qquad ( 2 )$$

$$\text{?} \text{indicates text missing or illegible when filed}$$

As cluster-centered precision is improved, EiCue helps map each patch i to a corresponding object based on the semantic structure. This functions as an important cue that emphasizes semantic distinction between different objects, and enhances discriminative power of feature embedding.

### Annotation

This is similar to previous study in that eigendecomposition is used, but the approach is differentiated in that a feature vector S is enhanced with a learnable segmentation head. On the other hand, the previous study depends on a static vector (for example, K). In this approach, S can be learned and adapted through differentiable eigen clustering, so that the graph Laplacian and object semantics can be evolved. Such dynamic integration of EiCue shows the uniqueness of a methodology different from the previous study.

### 1.3. EiCue-Based ObjNCELoss

For successful semantic segmentation, it is important not only to accurately classify the class of each pixel, but also to generate a segmentation map that aggregates the object representation and reflects the semantic representation of the object. From this perspective, learning relationships from the object-centric perspective is particularly important for a semantic segmentation task.

ObjNCELoss which is an object-centric contrastive learning strategy guided by EiCue is integrated to capture a complex relationship between the objects. This strategy was designed to refine a discriminative ability of feature embedding S to emphasize distinctiveness between various object semantics.

Prior to full-scale learning, projection features Z∈R^{N×D}^{_{Z}} and \tilde{Z}∈R^{N×D}^{_{Z}} derived from reconstructed S∈R^{N×D}^{_{S}} and \tilde{S}∈R^{N×D}^{_{S}}, respectively, using a linear projection head Z; are mapped. Here, actual dimension sizes of D_{S} and D_{Z} are maintained to be equal, but different notations are used for the convenience of description.

### 1.3.1 Object-Wise Prototypes

To extract representative object-level semantic features from the projection feature Z, a prototype Φ₁ that can be adopted to an object 1 based on the aforementioned EiCue is generated. A semantically representative prototype serves as a reference point at which objects with similar semantics are attracted and objects with different semantics are repelled.

How the prototype Φ is derived will be described. This represents object-level semantics based on the projection feature Z and the M_{eiCue} generated from the clustered eigen basis. Specifically, an object mask Mₗ is defined for each object 1 obtained from the M_{eiCue}. The mask Mₗ is set to Mₗ(i)=1 when M_{eiCue}(i)=l, and otherwise, to Mₗ(i)=0M, where i represents each position of the M_{eiCue}.

Then, the mask Mᵢ is applied to a projection feature tensor Z to obtain Zₗ=Z⊙Mₗ, where ⊙ represents a Hadamard product. Zₗ is a feature representation set of Z corresponding to the object 1. Next, a medoid is calculated to select a single vector from Zₗ and set as the object prototype Φₗ.

In this process, Iₗ is an index set of an object Il where

$${M}_{1}^{( i ∈ {I}_{1} )} = 1 ,$$

and represents an i-th feature vector of Zₗ⁽ⁱ⁾. Through this, the prototype Φₗ is derived from the masked tensor Zₗ.

$${Φ}_{1} = Z \text{?} for {m}^{*} = arg min \text{?} \sum \text{?} {‖ Z \text{?} - Z \text{?} ‖}_{2} . \qquad ( 3 )$$

$$\text{?} \text{indicates text missing or illegible when filed}$$

Therefore, Φₗ acts as a semantic vector of the object 1, and serves as an anchor for the object-centric contrastive loss.

### 1.3.2 Object-Centric Contrastive Loss

After the prototype Φ is calculated, an object-centric contrastive loss between the prototype Φ and the feature vector Z is performed. Specifically, the object-centric contrastive loss is defined as follows:

$$\text{?} = \frac{1}{N} \sum \text{?} [ - log ( \frac{exp ( ( Z \text{?} \cdot Φ \text{?} ) / τ )}{\sum \text{?} exp ( ( Z \text{?} \cdot Φ \text{?} ) / τ )} ) ] , \qquad ( 4 )$$

$$\text{?} \text{indicates text missing or illegible when filed}$$

where C represents the total number of Eigen objects predicted by M_{eiCue}, ⋅ is cosine similarity, and τ>0 is a temperature scalar. A loss weight w_{obj}⁽ⁱ⁾ is defined based on similarity information between vectors in order to emphasize an influence of feature vectors with high similarity and induce the model to focus on this. In this case, the weight is as follows:

$${w}_{obj}^{( i )} = \frac{1}{N} {\sum }_{j = 1}^{N} {K}_{sim} ( i , j )$$

where Kₛᵢₘ∈R^{N×N} is a similarity matrix defined as Kₛᵢₘ=KKT.

In Formula 4, object-level features are aggregated based on EiCue assignment, but strong coherence may be assigned through an optical augmented image \tilde{x}. Since optical augmentation does not apply a structural change, the augmented image \tilde{x} and an original image x are structurally the same, so that the following important assumption can be established: Vectors at the same position in Z and \tilde{Z} should have similar object-level semantics.

This assumption allows a new masked \tilde{Z} (\tilde{Z} in a green box in FIG. 1 of \tilde{x} to be generated based on the M_{eiCue} of x. Therefore, a contrastive loss is applied to the augmented image \tilde{x} using the prototype Φ of the non-augmented image x so that the model is induced to learn global semantic coherence. To describe this, a semantic coherence contrastive loss is defined as follows:

$$\text{?} = \frac{1}{N} \sum \text{?} {w}_{obj}^{( i )} [ - log ( \frac{exp ( ( Z \text{?} \cdot Φ \text{?} ) / τ )}{\sum \text{?} exp ( ( Z \text{?} \cdot Φ \text{?} ) / τ )} ) ] , \qquad ( 5 )$$

$$\text{?} \text{indicates text missing or illegible when filed}$$

Here,

$${\tilde{Z}}_{1}^{( i )}$$

represents an i-th feature vector of the projection feature \tilde{Z} for the object 1.

Specifically, the object-centric contrastive loss can be defined as follows:

$${L}_{nce}^{x \to \tilde{x}} = {λ}_{obj} {L}_{obj}^{x \to x} + {λ}_{sc} {L}_{sc}^{x \to \tilde{x}}$$

Here, 0<λ_{obj}<1 and 0<λ_{sc}<1 are hyperparameters for adjusting the strength of the loss, respectively. Since this loss function

$${L}_{nce}^{x \to \tilde{x}}$$

is asymmetric,

$${L}_{nce}^{\tilde{x} \to x} = {λ}_{obj} {L}_{nce}^{\tilde{x} \to \tilde{x}} + λ {L}_{sc}^{\tilde{x} \to x}$$

is defined in consideration of an opposite case. Therefore, an object-centric contrastive loss function ObjNCELoss to be finally optimized is as follows.

$$ℒ \text{?} = ℒ \text{?} + ℒ \text{?} . \qquad ( 6 )$$

$$\text{?} \text{indicates text missing or illegible when filed}$$

### 1.4. Total Objective

A corresponding distillation loss L_{corr} is additionally used to increase the stability of a training process from the beginning. Finally, the following total objective Lₜₒₜₐₗ is minimized.

$${ℒ}_{total} = {λ}_{nce} ℒ \text{?} + ( 1 - {λ}_{nce} ) {ℒ}_{corr} + {λ}_{eig} {ℒ}_{eig} , \qquad ( 7 )$$

$$\text{?} \text{indicates text missing or illegible when filed}$$

Here, 0≤λ_{nce}≤1 and 0≤λ_{eig}≤1 are hyperparameters. Here, λ_{nce} starts from 0 and increases rapidly, indicating that an influence of

$${L}_{nce}^{x ↔ \tilde{x}}$$

gradually increases in the learning process.

### 2. Experiments

Implementation details, including a dataset configuration, evaluation protocol, and detailed experimental setting, will be discussed. Then, EAGLE that is the proposed method is qualitatively and quantitatively evaluated through a fair comparison with existing state-of-the-art techniques. Further, effects of the proposed method are proved through an ablation study.

### 2.1. Experimental Settings

Implementation Details

A vision transformer FFF pretrained with DINO is used, and is fixed during a training process as in previous studies. A training set is cropped to five pieces after resizing, and a size of 244×244 is used. For the segmentation head S_{θ}, two MLP layers to which a ReLU activation function has been applied are used, and a single linear layer is constructed in a projection head Z_{ξ}. In all backbones, 512 is used as embedding dimensions D_{S} and D_{Z}. In EiCue, four eigenvectors are extracted from the eigen basis V. In an inference step, the segmentation map is postprocessed with DenseCRF.
Datasets

Evaluation is performed in the following three datasets: (1) COCO-Stuff, (2) Cityscapes, and (3) Potsdam-3. (1) The COCO-Stuff dataset includes a detailed pixel-level annotation to support various object understanding, and (2) Cityscapes contains various urban street scenes. (3) The Potsdam-3 dataset constitutes a satellite video. According to the class selection protocol of the previous study, 27 classes are used in COCO-Stuff and Cityscapes, and all 3 classes are used in Potsdam-3.
Evaluation Details

The evaluation protocol of the previous studies was adopted according to existing benchmarks. The evaluation includes the following. (1) Linear probe, in which representation quality is evaluated using a supervised linear layer in an unsupervised model, and (2) clustering, in which semantic segmentation is performed using a mini-batch K-means based on a cosine distance, and comparison with a correct answer is done via Hungarian matching. Performance is measured using pixel accuracy (Acc.) and a mean intersection over union (mIoU).

### 2.2. Evaluation Results

Here, the proposed method is carefully compared with existing unsupervised semantic segmentation (USS) studies qualitatively and quantitatively. Two representative existing studies that share the same evaluation protocol are set as main comparison targets and comparison is performed.

### Quantitative Evaluation: COCO-Stuff

In [Table 1], a new benchmark is set in the COCO-Stuff dataset according to a proposed EAGLE method.
(I) When a ViT-S/8 backbone is used, EAGLE shows a significant improvement in unsupervised learning accuracy compared to existing methods, in which the improvement is +15.9 over STEGO and is +7.0 over HP. Further, EAGLE showed excellent performance of +2.7 over STEGO and +2.6 over HP in unsupervised mIoU. In linear accuracy and mIoU, EAGLE also shows significant improvements of +2.4 (Acc.) and +5.6 (mIoU) over STEGO, and +1.2 (Acc.) and +1.2 (mIoU) over HP. Further, EAGLE achieved a performance advantage of +21.8 in the unsupervised mIoU and +8.9 in accuracy over SlotCon focusing on an object-level representation.
(II) Even when a ViT-S/16 backbone was used, EAGLE maintains an unsupervised learning accuracy advantage of +7.6 over STEGO and +5.6 over HP. Further, linear accuracy and mIoU of EAGLE are +4.6 (Acc.) and +8.0 (mIoU) which is excellent performance over STEGO, and +1.1 (Acc.) and +3.4 (mIoU) which is excellent performance over HP.

TABLE 1
Quantitative results on the COCO-Stuff dataset [4].

| | | Unsupervised | | Linear | |
|---|---|---|---|---|---|
| Method | Backbone | Acc. | mIoU | Acc. | mIoU |
| DC [5] | R18 + FPN | 19.9 | — | — | — |
| MDC [5] | R18 + FPN | 32.2 | 9.8 | 48.6 | 13.3 |
| IIC [20] | R18 + FPN | 21.8 | 6.7 | 44.5 | 8.4 |
| PiCIE [8] | R18 + FPN | 48.1 | 13.8 | 54.2 | 13.9 |
| PiCIE + H [8] | R18 + FPN | 50.0 | 14.4 | 54.8 | 14.8 |
| SlotCon [50] | R50 | 42.4 | 18.3 | — | — |
| DINO [6] | ViT-S/16 | 22.0 | 8.0 | 50.3 | 18.1 |
| +STEGO [15] | ViT-S/16 | 52.5 | 23.7 | 70.6 | 34.5 |
| +HP [43] | ViT-S/16 | 54.5 | 24.3 | 74.1 | 39.1 |
| +EAGLE (Ours) | ViT-S/16 | 60.1 | 24.4 | 75.2 | 42.5 |
| DINO [6] | ViT-S/8 | 28.7 | 11.3 | 68.6 | 33.9 |
| +TransFGU [52] | ViT-S/8 | 52.7 | 17.5 | — | — |
| +STEGO [15] | ViT-S/8 | 48.3 | 24.5 | 74.4 | 38.3 |
| +HP [43] | ViT-S/8 | 57.2 | 24.6 | 75.6 | 42.7 |
| +EAGLE (Ours) | ViT-S/8 | 64.2 | 27.2 | 76.8 | 43.9 |

### Quantitative Evaluation: Cityscapes

According to Table 2, EAGLE showed excellent performance in both ViT-S/8 and ViT-5 B/8 backbones in a Cityscapes dataset.
(I) In the case of the ViT-S/8 backbone, EAGLE achieved +3.9 (Acc.) and +2.9 (mIoU) improvements in unsupervised performance compared to existing STEGO, and showed +1.7 (Acc.) and +1.3 (mIoU) improvements compared to HP.
(II) In the ViT-B/8 backbone, EAGLE greatly improved the performance in both the unsupervised learning accuracy (Acc.) and mIoU. The Cityscapes dataset has a highly imbalanced pixel distribution where classes such as sky are greatly dominant compared to traffic light pixels, making it difficult to balance Acc. and mIoU. In fact, due to these characteristics, existing STEGO and HP showed conflicting advantages in Acc. and mIoU, whereas EAGLE effectively balanced such trade-offs and showed strong performance in both the indexes.

TABLE 2
Quantitative results on the Cityscapes dataset [9]

| | | Unsupervised | | Linear | |
|---|---|---|---|---|---|
| Method | Backbone | Acc. | mIoU | Acc. | mIoU |
| MDC [5] | R18 + FPN | 40.7 | 7.1 | — | — |
| IIC [20] | R18 + FPN | 47.9 | 6.4 | — | — |
| PiCIE [8] | R18 + FPN | 65.5 | 12.3 | — | — |
| DINO [6] | ViT-S/8 | 34.5 | 10.9 | 84.6 | 22.8 |
| +TransFGU [52] | ViT-S/8 | 77.9 | 16.8 | — | — |
| +HP [43] | ViT-S/8 | 80.1 | 18.4 | 91.2 | 30.6 |
| +EAGLE (Ours) | ViT-S/8 | 81.8 | 19.7 | 91.2 | 33.1 |
| DINO [6] | ViT-B/8 | 43.6 | 11.8 | 84.2 | 23.0 |
| +STEGO [15] | ViT-B/8 | 73.2 | 21.0 | 90.3 | 26.8 |
| +HP [43] | ViT-B/8 | 79.5 | 18.4 | 90.9 | 33.0 |
| +EAGLE (Ours) | ViT-B/8 | 79.4 | 22.1 | 91.4 | 33.4 |

### Qualitative Analysis

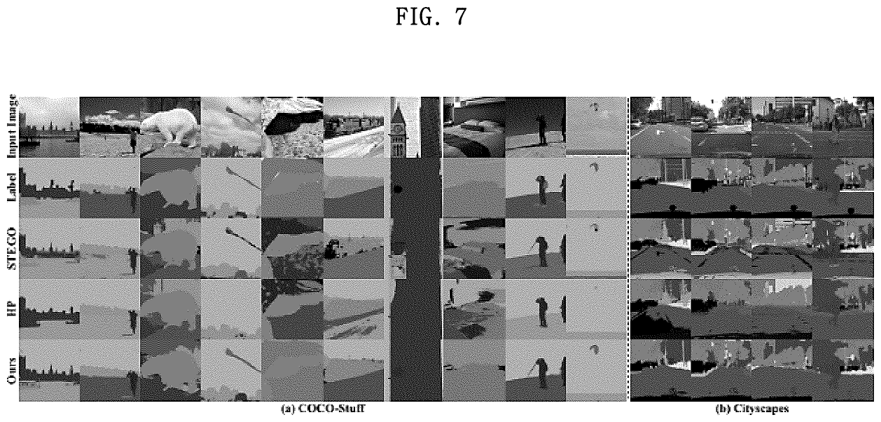

In FIG. 7, the EAGLE method trained for COCO-Stuff and Cityscapes datasets using ViT-S/8 and ViT-B/8 backbones is qualitatively compared with an existing state-of-the-art model.

EAGLE showed more excellent performance over an existing method in accurately segmenting objects and preserving details. On the other hand, there are problems in that STEGO tended to separate and segment several elements within a single object (for example, furniture or road), and HP missed small objects (for example, sports goods or traffic signs).

EAGLE showed the advantage of learning an image at an object level to understand an overall layout, as well as ascertaining a fine structure while ensuring that no objects are missed.

### 2.3. Ablation Study

For additional analysis of the EAGLE model, an ablation study was conducted, and results thereof will be discussed based on full ablation results shown in Experiment #1 to Experiment #7 in Table 3. A main experiment was conducted using the COCO-Stuff dataset and a ViT-S/8 model pretrained with DINO.
Effects of EiCue

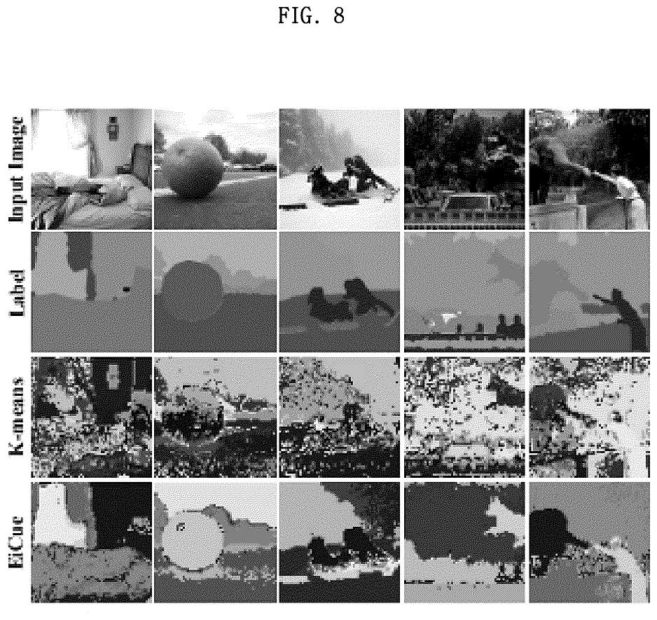

In Table 3, Experiment #6 using aK-means (Mₖₘ) approach was compared with Experiment #7 using an EiCue enhancement method to verify effects of EiCue (M_{eiCue}). EiCue results showed a great improvement in performance by capturing fine structural details that K-means misses. It can be confirmed from FIG. 8 that EAGLE visually identifies object semantics and structure better than the K-means.

TABLE 3
Table 3.
Ablation results on the COCO-Stuff dataset [4].

| | | | | | | | | Unsupervised | |
|---|---|---|---|---|---|---|---|---|---|
| Exp. # | L_{corr} | $\frac{x \to \overline{x}}{{L}_{obj} {L}_{sc}}$ | | $\frac{\overline{x} \to x}{{L}_{obj} {L}_{sc}}$ | | M_{eiCue} | Mₖₘ | Acc. | mIoU |
| 1 | ✓ | | | | | | | 46.9 | 21.8 |
| 2 | ✓ | | ✓ | ✓ | ✓ | ✓ | | 59.3 | 23.2 |
| 3 | ✓ | ✓ | | ✓ | | ✓ | | 62.1 | 25.1 |
| 4 | ✓ | | | | ✓ | ✓ | | 61.6 | 24.8 |
| 5 | ✓ | ✓ | ✓ | | | ✓ | | 62.9 | 26.1 |
| 6 | ✓ | ✓ | ✓ | ✓ | ✓ | | ✓ | 55.1 | 17.0 |
| 7 | ✓ | ✓ | ✓ | ✓ | ✓ | ✓ | | 64.2 | 27.2 |

ObjNCE Loss

Table 3 shows an influence of each loss component on the performance. It is emphasized that the overall model (Experiment #7) is more excellent than other configurations, and a combination of all components is effective. In particular, in Experiment #3 in which only L_{obj} was used, the performance is greatly improved over a basic model, and the importance of the object-centric representation is emphasized. It is shown that the addition of Lsc further refines the quality when Experiment #3 is compared with Experiment #7. It is also shown that Experiment #7 in which two-way Lnce were together used showed a synergistic effect compared to Experiments #4 and #5 in which was individually used.
Combination Between Hierarchical Attention and Eigengap

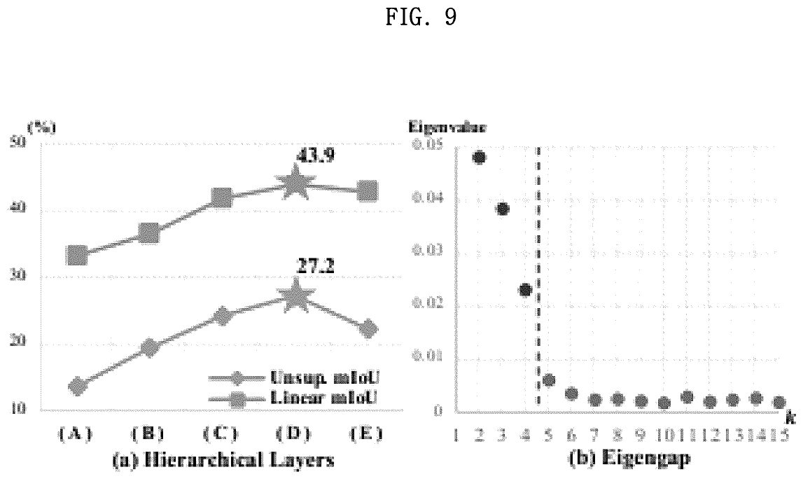

FIG. 9a presents results of various hierarchical attention combinations, and when last layers including a third layer, a second layer, and a last layer of a 12-layer architecture are combined, the best performance is shown. This is because substantially last layers better capture spatial information of the image. For optimal eigen basis clustering, eigengap analysis was performed in FIG. 9b. k was selected at a point where the eigengap is maximized, and k=4 was selected.

The present technology proposes EAGLE that is a novel method of solving a persistent problem of semantic segmentation by collecting semantic pairs from an object-centric perspective. Through empirical analysis using various datasets, EAGLE proves an excellent ability to accurately connect objects and semantic pairs by utilizing the Laplacian matrix constructed in an attention-based projection feature and enhancing an object-level prototype contrastive loss. This method utilizing advanced technology shows a significant advance in overcoming limitations of patch-level representation learning found in existing technology. As a result, EAGLE serves as a powerful framework for encompassing the semantic and structural complexity of an image in an unlabeled environment.

Although the preferred embodiments of the present invention have been described above, it will be understood by those skilled in the art that the present invention can be variously modified and changed without departing from the scope and spirit of the present invention described in the claims below.

[National Research and Development Project Supporting the Present Invention]

[Project Serial No] 2710006677

[Project No] RS-2020-II201361

[Name of department] Ministry of Science and ICT

[Task management (professional) institution name] Institute of Information and Communications Technology Planning and Evaluation

[Research Project name] Nurturing ICT and Broadcasting Innovation Talents (R&D)

[Research Task Name] Artificial Intelligence Graduate School Support Project (Yonsei University)

[Name of task performing organization] University Industry Foundation, Yonsei University

[Research period] 2024.01.01˜2024.12.31

### DETAILED DESCRIPTION OF MAIN ELEMENTS

100: Object-centric representation learning device through unsupervised semantic segmentation
110: Video encoding module
120: Eigen clustering module
130: Object-centric contrastive learning module

What is claimed is:

1. A device for object-centric representation learning through unsupervised semantic segmentation, the object-centric representation learning device comprising:
a video encoding module configured to receive an input video and generate a feature map;
an eigen clustering module configured to calculate an eigenvector representing a semantic structure of patches in the input video based on color affinity and semantic similarity of the input video, and generate a patch cluster for the patches in the input video through the eigenvector; and
an object-centric contrastive learning module configured to generate an object prototype based on the patch cluster and distinguish objects in the input video through semantic coherence based on the contrastive learning for the object prototype.

2. The device for object-centric representation learning through unsupervised semantic segmentation of claim 1, wherein the video encoding module receives an original video and a transformed video obtained by transforming the original video through a vision transformer (ViT) as input videos.

3. The device for object-centric representation learning through unsupervised semantic segmentation of claim 2, wherein the video encoding module extracts key features of different layers from the original video and the transformed video and integrates the key features to generate the feature map.

4. The device for object-centric representation learning through unsupervised semantic segmentation of claim 1, wherein the eigen clustering module segments the input video into patch units and calculates color affinity based on color information of each of the patches to generate a color affinity matrix.

5. The device for object-centric representation learning through unsupervised semantic segmentation of claim 4, wherein the Eigen clustering module performs an inner product between the patches on the feature map to generate a semantic similarity matrix indicating how semantically similar the respective patches are.

6. The device for object-centric representation learning through unsupervised semantic segmentation of claim 5, wherein the Eigen clustering module merges the color affinity matrix and the semantic similarity matrix to generate a Laplacian matrix, and eigendecomposes the Laplacian matrix to calculate the eigenvector.

7. The device for object-centric representation learning through unsupervised semantic segmentation of claim 6, wherein the Eigen clustering module performs K-means clustering for the patches in the input video through the eigenvector and classifies similar patches into the same object to generate the patch cluster (EiCue).

8. The device for object-centric representation learning through unsupervised semantic segmentation of claim 1, wherein the object-centric contrastive learning module selects a center vector from the patch cluster or calculates a mean vector to determine the object prototype.

9. The device for object-centric representation learning through unsupervised semantic segmentation of claim 8, wherein the object-centric contrastive learning module performs intra-video contrastive learning and inter-video contrastive learning for the object prototype to learn semantic coherence of the object.

10. The device for object-centric representation learning through unsupervised semantic segmentation of claim 9, wherein the object-centric contrastive learning module learns semantic distinction of the objects through contrastive learning between patch clusters.

11. A method for object-centric representation learning through unsupervised semantic segmentation performed in a device for object-centric representation learning through unsupervised semantic segmentation, the method for object-centric representation learning through unsupervised semantic segmentation comprising:
a video encoding step of receiving an input video and generating a feature map;
an eigen clustering step of generating an eigenvector representing a semantic structure of patches in the input video based on color affinity and semantic similarity of the input video, and generating a patch cluster for the patches in the input video through the eigenvector; and
an object-centric contrastive learning step of generating an object prototype based on the patch cluster and distinguishing objects in the input video through semantic coherence based on the contrastive learning for the object prototype.
